(19) United States
(12) Patent Application Publication
(10) Pub. No.: US 2007/0069141 A1
(43) Pub. Date: Mar. 29, 2007

(54) Color scintillator and image sensor

(75) Inventors: Koichi Nittoh, Kanagawa-Ken (JP); Kunihiko Nakayama, Tokyo (JP); Keisuke Kitsukawa, Kanagawa-Ken (JP); Motohisa Abe, Ibaraki-Ken (JP); Takashi Noji, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/573,653

(22) PCT Filed: Sep. 29, 2004
(86) PCT No.: PCT/JP04/14714

§ 371 Date: Mar. 28, 2006

(30) Foreign Application Priority Data
Sep. 29, 2003 (JP) 2003-338366

(51) Int. Cl. G01T 1/20

(52) U.S. Cl. 250/367

(57) ABSTRACT

A color scintillator 26 comprises: an optical substrate 30 having bundled optical fibers; an acicular scintillator 50 provided with the optical substrate 30, the acicular scintillator having either of an acicular crystal structure and a columnar crystal structure, the acicular scintillator reacting with at least one of an electromagnetic wave and a radial ray into light emitting; and a coating scintillator 51 coating the acicular scintillator 50, the coating scintillator reacting with at least one of another electromagnetic wave and another radial ray which differ in either of an energy and a type from the electromagnetic wave and the radial ray reacting with the acicular scintillator 50 into light emitting in a different color from an emitting color in the acicular scintillator 50.

### TECHNICAL FIELD

The present invention relates to a color scintillator converting electromagnetic waves and radial rays which vary in type or energy to visible lights identifiably and an image sensor generating images using visible lights converted by a color scintillator.

### BACKGROUND ART

When radial rays such as X-rays and γ-rays pass through objects, the absorption and dispersion of the radial rays in the objects vary according to the shapes of the objects through which the radial rays pass through and the varieties of the materials of the objects. By means of this characteristic, information such as broken states, changes, and filling states inside the objects can be obtained by measuring the strengths of the radial rays that pass through the objects. The strengths of these radial rays are visualized and recorded with recording means such as photography, video recording, and digital files.

Methods for observing states inside objects or samples without destroying the objects and the samples by means of the radial rays that pass through the objects are referred to as radiography or non-destructive radiography. Examples of non-destructive radiography include X-ray photographs, which are used in known medical diagnosis, for examining internal states of human bodies.

Electromagnetic waves such as ultraviolet rays and visible lights instead of radial rays are also available for the non-destructive radiography.

To date, an X-ray image intensifier 1 shown in FIG. 5 functioning as an image sensor whose sensitivity of an imaging system is improved is used in the non-destructive radiography that is utilized in medical diagnosis and industrial non-destructive inspection.

In the known X-ray image intensifier 1, electromagnetic rays or radial rays, for example, X-rays E1, emitted from an X-ray tube 2 and passing through an object enter an incidence face 4 of a tube case 3, and then enter a scintillator 5 composed of materials such as cesium iodide (CsI) via an aluminum (Al) substrate arranged inside the tube case 3. The scintillator 5 scintillates as a result of reaction with the incident X-rays E1 to convert the X-rays E1 to light beams. The light beams are then converted into electrical signals E2 in a photosensor 6.

Next, in a vacuum area 8 inside an image intensifier tube 7 closed with the Al substrate, the electrical signals E2 converted in the photosensor 6 are concentrated and amplified to an output image size of S1, and then lead toward an anode 11 by the action of an electric field generated by the operation of a high-voltage power supply 9 and an internal electrode 10.

Furthermore, the electrical signals E2 are converted into images E3 in a fluorescent material 12 arranged at an end of the image intensifier tube 7. The images E3 of objects are output from the output face of the fluorescent material 12, and captured by a camera 14 arranged such that a lens 13 thereof faces the output face of the fluorescent material 12.

In order to improve the sensitivity of the X-ray image intensifier 1, the reaction area where the scintillator 5 reacts with the X-rays E1, i.e., an effective incident area S2 in the incidence face 4 of the tube case 3, may be increased. However, positional resolution of measurement is reduced as the effective incident area S2 is increased. That is to say, when one of the sensitivity and the resolution of the image sensor is improved, the other is reduced.

The conventionally used X-ray image intensifier 1 converts light beams into the electrical signals E2 and then amplifies the electrical signals E2 instead of increasing effective incident area S2, i.e., the emitting area of the scintillator 5. That is to say, the X-ray image intensifier 1 can be regarded as an image sensor having a function of amplifying electrons of the electrical signals E2.

On the other hand, in order to achieve high resolution with low sensitivity, irradiation time of radial rays may be increased so as to carry out the measurement by means of integration. In this method, recording media such as films and photostimulable fluorescent sheets are used. However, in the measurement using such recording media, indirect operations such as development and reading work are required to obtain the internal structure of the objects in the form of image data, resulting in lack of real-time processing.

When radial rays that vary in type and energy or electromagnetic waves such as ultraviolet rays and light beams that vary in wavelength passing through objects are measured so as to obtain the differences in the measured values according to the differences between the radial rays or the electromagnetic waves, each of the radial rays or the electromagnetic waves is required to be measured individually.

For example, when neutron beams and the X-rays E1 are used for the measurement, the scintillator 5 that reacts with the X-rays E1 needs to be replaced with the scintillator that reacts with the neutron beams.

Accordingly, in order to measure radial rays that vary in type and energy or electromagnetic waves that vary in wavelength at the same time, configurations of a color scintillator and methods in capable of measuring radial rays that vary in type and energy or electromagnetic waves that vary in wavelength in terms of color with keeping characteristics of the radial rays or electromagnetic waves have been proposed (see, for example, U.S. Pat. No. 6,313,465 and Japanese Patent Application (Laid-Open) No. H11-271453)

In image sensors including such a color scintillator capable of measuring different radial rays or electromagnetic waves in terms of color, an effective incident area S2 is also increased so as to improve the sensitivity. Also, when the image sensors include photosensors that convert the light beams emitted by the color scintillator into electrical signals, the radial rays and the electromagnetic waves are converted into electrical signals and then the converted electrical signals are amplified by amplifying means such as the X-ray image intensifier 1 and a micro-channel plate.

When the X-ray image intensifier 1 is used as an image sensor, an electron lens 16 of an adjustable-field type having radial electric equipotential lines 15 shown in FIG. 6 is formed in the vacuum area 8 inside the image intensifier tube such that orbitals 17 of electrons are formed radially converge in order to amplify the energy of electrons.

Therefore, in the image sensor including the X-ray image intensifier 1, the color scintillator functioning as the input face of radial rays and electromagnetic waves and the photoelectric-conversion face of the photosensor are required to be geometrically curved due to the orientations of the electric equipotential lines 15 such that the electrical signals E2 are amplified and the images E3 are formed.

As a result, in the light-emitting portion of the color scintillator that reacts with radial rays and electromagnetic waves, for example, the X-rays E1, the incident angles of the X-rays E1 to the color scintillator are gradually inclined from right angle with distance from the central portion toward the outer portion as shown in FIG. 7. Accordingly, the resolution adjacent to the outer portion of the light-emitting portion of the color scintillator is less than that adjacent to the central portion.

When the thickness of the color scintillator is relatively small, for example, when a surface of the color scintillator adjacent to the photoelectric face of the photosensor 6 is supposedly located at the position shown by a dotted line in FIG. 7, the difference between the reaction area in the central portion and that in the outer portion of the light-emitting portion of the color scintillator, that react with the X-rays E1, is small. Accordingly, the influences on the resolution may be small.

Since the practical color scintillator has a constant thickness as shown in FIG. 7, the X-rays E1 enter on the outer portion of the light-emitting portion of the color scintillator in an oblique direction. Therefore, the reaction area of the color scintillator that reacts with the X-rays E1 in the outer portion is larger than that in the central portion. As a result, the number of light components generated as a result of the reaction with the X-rays E1 is steeply increased with distance from the central portion of the light-emitting portion of the color scintillator toward the outer portion, resulting in a reduction in resolution.

That is to say, in order to improve the resolution in the outer portion of the light-emitting portion of the color scintillator, the incidence face of the color scintillator on which the X-rays E1 enter is required to be flat. In contrast, in order to amplify the electrical signals converted in the photosensor 6, the color scintillator is required to be curved such that the electron lens 16 is formed.

However, configurations or structures of the color scintillator or the photosensor 6 that can satisfy such conflicting requirements have not yet to be invented.

Meanwhile, when a micro-channel plate is used as an image sensor, the channel interval of the micro-channel plate corresponds to the resolution of the image sensor. Therefore, in order to improve the resolution of the image sensor, a micro-channel plate having a channel interval of the size of microns is required. Moreover, amplifying characteristics between channels are required to be uniform.

In short, in the known scintillator 5 and image sensors, reduction in resolution is unavoidable when improving the measurement sensitivity as described above. When the color scintillator capable of measuring radial rays and electromagnetic waves that vary in type and energy in terms of color is used, configurations or methods capable of amplifying electrical signals such that the sensitivity is improved without reducing the resolution are also required.

### SUMMARY OF THE INVENTION

The present invention has been achieved to meet such a demand and an object of the present invention is to provide a color scintillator converting electromagnetic waves and radial rays which vary in type or energy to visible lights more simultaneously and effectively with less radiation dosage or less light intensity.

Another object of the present invention is to provide an image sensor converting electromagnetic waves and radial rays which vary in type or energy to visible lights simultaneously with its color scintillator and amplifying the converted visible lights effectively without reducing resolution so as to get differences in measured values due to differences in the types or energies of the electromagnetic waves and radial rays with high sensitivity.

The present invention provides a color scintillator comprising: an optical substrate having bundled optical fibers; an acicular scintillator provided with the optical substrate, the acicular scintillator having either of an acicular crystal structure and a columnar crystal structure, the acicular scintillator reacting with at least one of an electromagnetic wave and a radial ray into light emitting; and a coating scintillator coating the acicular scintillator, the coating scintillator reacting with at least one of another electromagnetic wave and another radial ray which differ in either of an energy and a type from the electromagnetic wave and the radial ray reacting with the acicular scintillator into light emitting in a different color from an emitting color in the acicular scintillator, in an aspect to achieve the object, as described in the claim 1.

The present invention also provides a color scintillator comprising: an optical substrate having bundled optical fibers; an acicular scintillator provided with the optical substrate, the acicular scintillator having either of an acicular crystal structure and a columnar crystal structure, the acicular scintillator reacting with at least one of an electromagnetic wave and a radial ray into light emitting; and a coating scintillator coating the acicular scintillator, the coating scintillator reacting with at least one of another electromagnetic wave and another radial ray which differ in either of an energy and a type from the electromagnetic wave and the radial ray reacting with the acicular scintillator into light emitting in a different emission lifetime from that in the acicular scintillator, in an aspect to achieve the object, as described in the claim 2.

The present invention also provides a color scintillator comprising: an optical substrate having bundled optical fibers; an acicular scintillator provided with the optical substrate, the acicular scintillator having either of an acicular crystal structure and a columnar crystal structure, the acicular scintillator reacting with at least one of an electromagnetic wave and a radial ray into light emitting; and a coating scintillator coating the acicular scintillator, the coating scintillator reacting with at least one of another electromagnetic wave and another radial ray which differ in either of an energy and a type from the electromagnetic wave and the radial ray reacting with the acicular scintillator into light emitting in a different color and a different emission lifetime from those in the acicular scintillator, in an aspect to achieve the object, as described in the claim 3.

The present invention also provides a color scintillator comprising: an optical substrate having bundled optical fibers; an acicular scintillator provided with the optical substrate, the acicular scintillator having either of an acicular crystal structure and a columnar crystal structure, the acicular scintillator reacting with at least one of an electromagnetic wave and a radial ray into light emitting; and a coating scintillator coating the acicular scintillator, the coating scintillator reacting with at least one of another electromagnetic wave and another radial ray which differ in either of an energy and a type from the electromagnetic wave and the radial ray reacting with the acicular scintillator into light emitting in a different emitting condition from that in the acicular scintillator, in an aspect to achieve the object, as described in the claim 4.

### BRIEF DESCRIPTION OF THE DRAWINGS

FIG. 1 is a structural drawing showing an image sensor according to a first embodiment of the present invention;

FIG. 2 is an enlarged sectional view of the color scintillator and the photosensor shown in FIG. 1;

FIG. 3 is a diagram showing an example of image of an object obtained by using a plurality of scintillators having mutually difference structures;

FIG. 4 is a structural drawing showing an image sensor according to a second embodiment of the present invention;

FIG. 5 is a structural drawing showing a conventional X-ray image intensifier;

FIG. 6 is a drawing showing a structure of an electron lens formed by the conventional X-ray image intensifier shown in FIG. 5; and

FIG. 7 is an enlarged structural drawing showing a light-emitting portion of the conventional color scintillator shown in FIG. 5.

### BEST MODE FOR CARRYING OUT THE INVENTION

A color scintillator and an image sensor according to embodiments of the present invention will be described with reference to the accompanying drawings.

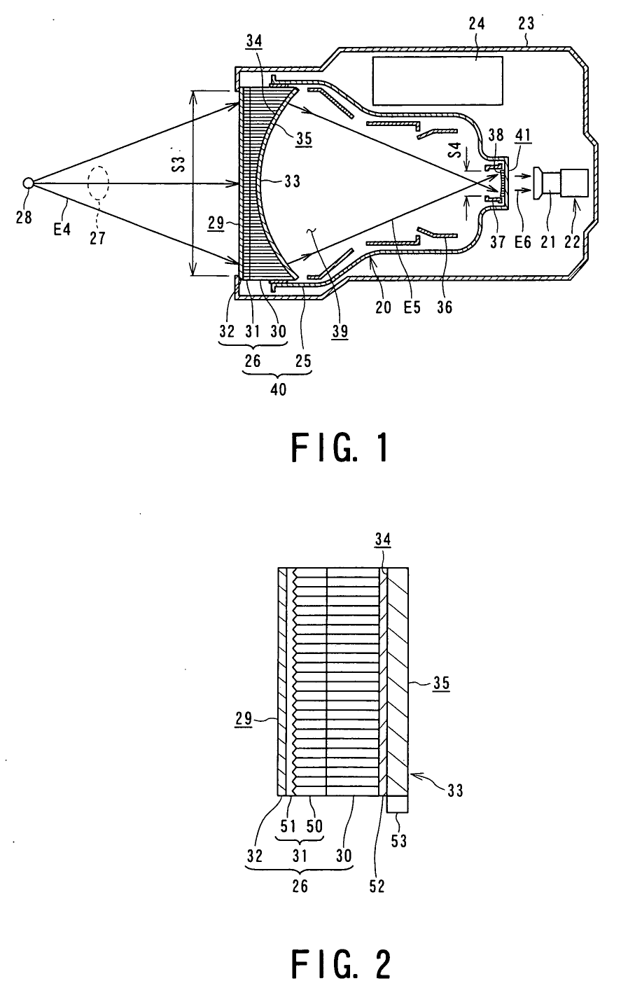

FIG. 1 is a structural drawing showing an image sensor according to a first embodiment of the present invention.

An image intensifier 20 1 as an example of image sensors and a color camera 22 including a lens 21 are housed in a tube case 23. The image intensifier 20 includes a high-voltage power supply 24 and a stepped image intensifier tube 25 having a closed end. The opening of the image intensifier tube 25 is closed with a color scintillator 26.

The color scintillator 26 that closes the opening of the image intensifier tube 25 is arranged at an open end of the tube case 23. E1ectromagnetic waves or radial rays, for example, X-rays E4 emitted from an X-ray tube 28 that is arranged outside the tube case 23 and passing through an object 27, whose images are to be captured enter on a flat incidence face 29 of the color scintillator 26. Thus, the area of the color scintillator 26 facing the exterior of the tube case 23 corresponds to an effective incident area S3 for the X-rays E4.

Moreover, the color scintillator 26 includes a fiber-optic plate 30 as an example of an optical substrate, a scintillator layer 31 capable of converting radial rays and electromagnetic waves such as the X-rays E4 into light beams arranged on the fiber-optic plate 30, and a resin sheet 32 protecting the scintillator layer 31. The resin sheet 32 of the color scintillator 26 arranged at the open end of the tube case 23 functions as the incidence face 29 for the X-rays E4.

The color scintillator 26 has a surface curved in a predetermined curvature adjacent to the interior of the image intensifier tube 25, and a photosensor 33 is arranged on this curved surface. The photosensor 33 has an input face 34 for light beams curved in a predetermined curvature adjacent to the color scintillator 26, and has a photoelectric face 35 curved in a predetermined curvature adjacent to the interior of the image intensifier tube 25.

The X-rays E4 incident on the resin sheet 32 that functions as the incidence face 29 for the X-rays E4 are converted into light beams in the scintillator layer 31, and the light beams are received by the photosensor 33 via the fiber-optic plate 30.

Moreover, a plurality of internal electrodes 36 is arranged inside the image intensifier tube 25. An electric field can be generated by applying voltages to the internal electrodes 36 inside the image intensifier tube 25 with the high-voltage power supply 24.

On the other hand, an anode 37 is arranged inside the image intensifier tube 25 adjacent to the closed end. Furthermore, an output scintillator 38 is arranged on the inner surface of the image intensifier tube 25 adjacent to the closed end. The face of the output scintillator 38 adjacent to the photosensor 33 is curved at a predetermined curvature according to the curvature of the photoelectric face 35 of the photosensor 33, whereas the face adjacent to the closed end of the image intensifier tube 25 is flat.

The output scintillator 38 can convert electrons inside the image intensifier tube 25 into light beams of red, green, and blue having different luminescence ratios depending on the intensities of the electrons. In other words, the output scintillator 38 functions as a color scintillator.

The interior of the image intensifier tube 25 closed with the color scintillator 26 is decompressed such that a vacuum area 39 is formed. That is to say, the image intensifier tube 25 and the color scintillator 26 closing the image intensifier tube 25 both function as parts of a vacuum vessel 40.

As a result, the image intensifier tube 25 serves both as the vacuum vessel 40 and a discharge tube having the photoelectric face 35 of the photosensor 33 as a cathode, and forms an electron lens between the cathode and the anode 37. Thus, the image intensifier tube 25, the internal electrodes 36, the high-voltage power supply 24, the photoelectric face 35 of the photosensor 33 having a predetermined curvature and functioning as the cathode, and the anode 37 form the electron lens; and the operation of the electric field of the electron lens forms an electrical-signal-amplify-means that accelerates electrons.

Light beams received on the input face 34 of the photosensor 33 are converted into electrical signals E5, and electrons discharged from the photoelectric face 35 of the photosensor 33 as the electrical signals E5 are amplified into an output image size of S4 by the operation of the electron lens. The amplified electrical signals E5 are then incident on the output scintillator 38.

The output scintillator 38 has a flat fluorescent output face 41 adjacent to the closed end of the image intensifier tube 25 for outputting images of the object 27. The lens 21 of the color camera 22 faces the fluorescent output face 41 of the output scintillator 38. The amplified electrical signals E5 incident on the output scintillator 38 are converted into color images E6, and the color images E6 are formed on the fluorescent output face 41. The color images E6 are then captured by the color camera 22.

Next, an example of a detailed configuration of the color scintillator 26 and the photosensor 33 will be described.

FIG. 2 is an enlarged sectional view of the color scintillator 26 and the photosensor 33 shown in FIG. 1.

The color scintillator 26 is arranged adjacent to the input face 34 of the photosensor 33 such as a CMOS (Complementary Metal-Oxide Semiconductor) sensor and a CCD (Charge Coupled Device) sensor.

Instead of amplifying the electrical signals E5 converted by the photosensor 33 such as a CMOS sensor and a CCD sensor in the image intensifier tube 25 before capturing with a camera, a camera such as a CMOS camera and a CCD camera including light-receiving elements may directly capture light beams from the color scintillator 26.

The color scintillator 26 includes the fiber-optic plate 30 and the scintillator layer 31 arranged thereon. The boundary plane between the fiber-optic plate 30 and the scintillator layer 31 is flat. That is to say, a face of the fiber-optic plate 30 adjacent to the scintillator layer 31 from which light beams are input is flat, whereas the other face adjacent to the photosensor 33 from which the light beams are output is curved.

Furthermore, the other face of the scintillator layer 31 remote from the fiber-optic plate 30 is flat, and is protected by the flat resin sheet 32 serving as a protective film.

The scintillator layer 31 of the color scintillator 26 includes an acicular scintillator 50 and a coating scintillator 51 coating the acicular scintillator 50. The acicular scintillator 50 is arranged adjacent to the fiber-optic plate 30, and an area of the acicular scintillator 50 remote from the fiber-optic plate 30 is coated with the coating scintillator 51.

The acicular scintillator 50 of the scintillator layer 31 includes a plurality of cells having an acicular crystal structure of which one end is sharp or a columnar crystal structure. That is to say, the acicular scintillator 50 is an optical fiber bundle. Since light beams inside the acicular scintillator 50 travel in one direction while being perfectly reflected inside the cells, a reduction in sensitivity of the color scintillator 26 can be suppressed.

Therefore, when the thickness of the acicular scintillator 50 is further increased, the reaction area with the X-rays E4 is increased, resulting in an improvement in sensitivity of the image intensifier 20. However, when the acicular scintillator 50 is too thick, the reaction area of the acicular scintillator 50 reacting with the X-rays E4 entering in the oblique direction is larger than that for the X-rays E4 entering in the perpendicular direction. Accordingly, the resolution of the acicular scintillator 50 in the outer portion may be disadvantageously reduced compared with that in the central portion.

In order to suppress the reduction in the resolution even when the thickness of the acicular scintillator 50 is increased for improving the sensitivity, the area of the acicular scintillator 50 from which the X-rays E4 enter is coated with the coating scintillator 51.

The coating scintillator 51 includes several types of powdered scintillator particles of a few to dozens of micrometers in diameter. Thus, the oblique components of the X-rays E4 are reduced by the operation of the coating scintillator 51, and the reduction in the resolution can be suppressed even when the thickness of the acicular scintillator 50 is increased for improving the sensitivity.

Examples of constituent materials of the scintillator layer 31 will now be described.

In order to exhibit different reactions for radial rays and electromagnetic waves that vary in terms of type and energy, the color scintillator 26 has a function to discriminate the radial rays and the electromagnetic waves that vary in type and energy. Therefore, the materials for the scintillator layer 31 of the color scintillator 26 include fluorescent materials each reacting with radial rays and electromagnetic waves of a corresponding type and energy.

That is to say, the acicular scintillator 50 and the coating scintillator 51 at least include fluorescent materials different from each other. The acicular scintillator 50 includes one or more fluorescent materials, and the coating scintillator 51 also includes one or more fluorescent materials.

First, examples of constituent materials of the color scintillator 26 that enable radial rays or electromagnetic waves that vary in type to be measured in terms of color at the same time will be described.

When radial rays incident on the color scintillator 26 are thermal neutron rays and X-rays or γ-rays, a fluorescent material containing an element that reacts with thermal neutron rays and a fluorescent material containing an element that reacts with X-rays or γ-rays are selected.

Examples of the fluorescent material containing an element that reacts with thermal neutron rays include a fluorescent material containing gadolinium (Gd) that induces a (n,γ) reaction with thermal neutrons, and a fluorescent material containing boron (¹⁰B) or lithium (⁶Li) that induces a (n,α) reaction with thermal neutrons.

When thermal neutron rays enter on the fluorescent material containing gadolinium, the cross-section of the thermal neutron reaction between the thermal neutrons and gadolinium is relatively large. Accordingly, the thermal neutron rays do not pass through the fluorescent material even when the thickness of the fluorescent material is approximately 150 μm, whereas high-energy X-rays or γ-rays pass through the fluorescent material containing gadolinium even when the thickness of the fluorescent material is 500 μm.

When the photosensor 33 is a CMOS sensor or a CCD sensor, or when light beams from the color scintillator 26 are captured by a camera such as a CMOS camera and a CCD camera including light-receiving elements, CsI having a high conversion rate of received light can be effectively used for the acicular scintillator 50.

Thus, as a fluorescent material that reacts with thermal neutron rays, a red fluorescent material composed of europium-activated gadolinium oxysulfide (Gd₂O₂S:Eu) is used for the coating scintillator 51.

On the other hand, as a fluorescent material that reacts with X-rays or γ-rays, a fluorescent material composed of CsI is used for the acicular scintillator 50. Two main examples of the fluorescent material composed of CsI are a green fluorescent material composed of thallium-activated cesium iodide (CsI:Tl) emitting light beams having a dominant wavelength of 540 nm, and a blue fluorescent material composed of sodium-activated cesium iodide (CsI:Na) emitting light beams having a dominant wave length of 420 nm.

In order to prevent deterioration of performance due to hygroscopicity of CsI, the acicular scintillator 50 composed of CsI is preferably coated with a protective material such as silicon carbide (SiC).

Furthermore, in order to improve the sensitivity to X-rays and γ-rays, terbium-activated lanthanum oxysulfide (La₂O₂S:Tb) serving as a green fluorescent material having a small cross-section of the thermal neutron reaction or terbium-activated yttrium oxysulfide (Y₂O₂S:Tb) serving as a red fluorescent material may be arranged between a red fluorescent material composed of Gd₂O₂S:Eu and the acicular scintillator 50 composed of CsI as the coating scintillator 51 or as the acicular scintillator 50 so as to form a three-layer structure.

When the scintillator layer 31 is a three-layer structure composed of Gd₂O₂S:Eu, La₂O₂S:Tb or Y₂O₂S:Tb, and CsI; the scintillator layer 31 reacts with thermal neutrons to emit red light beams, and at the same time, reacts with X-rays or γ-rays to emit green light beams. Thus, thermal neutron rays and electromagnetic waves such as X-rays or γ-rays are measured in terms of color.

On the other hands, when radial rays incident on the color scintillator 26 are β-rays and X-rays or γ-rays, a fluorescent material containing an element that reacts with β-rays and a fluorescent material containing an element that reacts with X-rays or γ-rays are selected.

Since the range of β-rays is shorter than those of X-rays and γ-rays, the scintillator layer 31 having the same constituent materials as those used when thermal neutron rays and X-rays or γ-rays enter on the color scintillator 26 can be used.

Moreover, europium-activated yttrium oxysulfide (Y₂O₂S:Eu) serving as a red fluorescent material or europium-activated lanthanum oxysulfide (La₂O₂S:Eu) serving as a green fluorescent material each not containing gadolinium may be arranged between the coating scintillator 51 composed of Gd₂O₂S:Eu and the acicular scintillator 50 composed of CsI so as to form the scintillator layer 31 of a three-layer structure. This scintillator layer 31 can also measure β-rays and X-rays or γ-rays identifiably in terms of color at the same time.

Similarly, when radial rays or ultraviolet rays incident on the color scintillator 26 are ultraviolet rays and X-rays or γ-rays, a fluorescent material containing an element that reacts with ultraviolet rays and a fluorescent material containing an element that reacts with X-rays or γ-rays are selected for the scintillator layer 31. Thus, ultraviolet rays and X-rays or γ-rays are measured identifiably in terms of color at the same time.

Next, examples of constituent materials of the color scintillator 26 that enable radial rays or electromagnetic waves that vary in energy to be measured in terms of color at the same time will be described.

When radial rays or electromagnetic waves that vary in energy are measured in terms of color at the same time, relationships between K-absorption edges and energy absorption coefficients or specific gravities of elements for the scintillator layer 31 are utilized. According to the characteristics of the constituent elements, the energy absorption coefficients of the elements for the scintillator layer 31 become large as the energy of radial rays or electromagnetic waves, for example, X-rays is small, and the occurrence of the reactions with radial rays or electromagnetic waves becomes large within a short range as the specific gravities of the elements for the scintillator layer 31 are large.

Thus, Y₂O₂S:Eu or Gd₂O₂S:Eu serving as a red fluorescent material can be used for the coating scintillator 51. Y₂O₂S:Eu has a specific gravity of 4.9 and a K-absorption edge of 17 keV, and Gd₂O₂S:Eu has a specific gravity of 7.3 and a K-absorption edge of 50.2 keV.

Moreover, CsI serving as a green fluorescent material is used for the acicular scintillator 50.

Furthermore, cadmium tungstate (CdWO₄) serving as a green fluorescent material having a specific gravity of 7.9 and a K-absorption edge of 69.5 keV may be arranged between CsI:Tl serving as a green fluorescent material and Y₂O₂S:Eu or Gd₂O₂S:Eu serving as a red fluorescent material. Such a scintillator layer 31 having a three-layer structure is effective in improving sensitivity.

When X-rays that vary in energy enter on the scintillator layer 31 of the three-layer structure having CsI:Tl, CdWO₄, and Y₂O₂S:Eu or Gd₂O₂S:Eu layers; the scintillator layer 31 emits red light beams as a result of reaction with the low-energy X-ray components, and emits green light beams as a result of reaction with the high-energy X-ray components.

Also, a three-layer structure having Y₂O₂S:Eu or Gd₂O₂S:Eu serving as a red fluorescent material for the coating scintillator 51, CsI:Na serving as a blue fluorescent material for the acicular scintillator 50, and calcium tungstate (scheelite; CaWO₄) serving as a blue fluorescent material having a K-absorption edge of 69.5 keV and a specific gravity of 6.1 can separately convert X-rays that vary in energy into red light beams and blue light beams.

Next, an example of constituent materials of the color scintillator 26 that enable radial rays or electromagnetic waves that vary in type and energy to be simultaneously measured not in terms of color but by means of differences in emission lifetimes of fluorescent materials will be described.

Radial rays or electromagnetic waves that vary in type and energy can be discriminated by means of the scintillator layer 31 composed of fluorescent materials whose emission lifetimes, i.e., the durations in which the brightness is reduced to one tenth of the original brightness, are different.

For example, the emission lifetime of CsI:Na serving as a blue fluorescent material used for the acicular scintillator 50 is relatively short (0.63 μs), but the emission lifetime of CaWO₄ serving as a blue fluorescent material that emits the same blue light beams as CsI:Na is sufficiently long (10 μs) compared with that of CsI:Na.

As a result, when pulses of X-rays that vary in energy enter on the scintillator layer 31 composed of CsI:Na and CaWO₄, the X-rays can be discriminated in terms of energy even though the emitted light beams are both blue. In other words, when images are observed later than the period of emission occurring as a result of the reaction between the scintillator layer 31 and X-rays, the light beams can be discriminated as those emitted by CsI:Na or those emitted by CaWO₄ due to the differences in emission lifetimes between CsI:Na and CaWO₄ even though the emitted light beams are both blue. Thus, X-rays that vary in energy can be observed in terms of energy at the same time.

Similarly, the emission lifetime of Y₂O₂S:Tb serving as a green fluorescent material is 2.7 ms, and that of Y₂O₂S:Eu serving as a red fluorescent material is 2.5 ms. Therefore, by adjusting the observation time, radial rays or electromagnetic waves can be discriminated in terms of energy or type by means of the scintillator layer 31 composed of fluorescent materials whose emission lifetimes are different.

Furthermore, the scintillator layer 31 composed of fluorescent materials having not only different emission lifetimes but also different luminescent colors can improve the discrimination performance.

On the other hand, materials such as polyethylene terephthalate (PET) are used for the resin sheet 32 of the color scintillator 26. When the color of the resin sheet 32 is white, the resin sheet 32 functions as a reflective film that reflects the light beams emitted from the color scintillator 26 toward the photosensor 33. This can lead to an improvement in the sensitivity.

Moreover, when the color of the resin sheet 32 is transparent and colorless or when the material of the resin sheet 32 is pervious to ultraviolet rays easily, electromagnetic waves from ultraviolet rays to light having short wavelengths can be measured as excitation light sources. For example, the resin sheet 32 can be used for image sensors that detect ultraviolet rays emitted as a result of the reaction between radial rays or laser beams and objects as signals, or for image sensors such as ultraviolet microscopes having ultraviolet rays as light sources.

Furthermore, the fiber-optic plate 30 includes a plurality of columnar optical fibers bundled such that the optical fibers are aligned with the cells of the acicular scintillator 50. Therefore, the fiber-optic plate 30 can transmit light beams without attenuation. In other words, when a CMOS sensor or a CCD sensor having a flat light-receiving face is used as the photosensor 33, the fiber-optic plate 30 functions as an optical substrate that can efficiently transmit light beams unlike inefficient transmitting means such as a lens.

Also, the fiber-optic plate 30 can shield radial rays such as X-rays passing through the scintillator layer 31. When radial rays such as X-rays and β-rays are measured, the photosensor 33 such as a CMOS sensor and a CCD sensor may be damaged by the radial rays passing through the scintillator layer 31. To avoid this damage, the fiber-optic plate 30 for shielding the photosensor 33 from the radial rays is provided.

Furthermore, in order to form an electron lens for amplifying the electrical signals ES converted in the photosensor 33, the interior of the image intensifier tube 25 closed with the color scintillator 26 needs to be evacuated. Therefore, the fiber-optic plate 30 having a plurality of bundled thin glass components with a constant strength used as an optical substrate of the color scintillator 26, for example, can keep the interior of the image intensifier tube 25 evacuated and can add a predetermined strength to the color scintillator 26.

Moreover, the photosensor 33 is provided with a filtering mechanism 52 such as color filters and a timing adjustment mechanism 53. The filtering mechanism 52 of the photosensor 33 can sort wavelengths of light beams to be received. Accordingly, the photosensor 33 can receive light beams with predetermined wavelengths sorted from those with various wavelengths emitted from the color scintillator 26. That is to say, when radial rays or electromagnetic waves that vary in energy and type are converted into light beams in terms of color in the color scintillator 26, the light beams are converted into the electrical signals E5 such that the radial rays or the electromagnetic waves are appropriately distinguished.

The timing adjustment mechanism 53 of the photosensor 33 can adjust the timing for receiving the light beams emitted from the color scintillator 26. Accordingly, when radial rays or electromagnetic waves that vary in energy and type are converted into light beams by fluorescent materials having different emission lifetimes in the color scintillator 26, the light beams are received with an appropriate timing, and converted into the electrical signals ES such that the radial rays or the electromagnetic waves can be distinguished.

An example of the timing adjustment mechanism 53 is a timing adjustment circuit for controlling the timing of receiving light beams and the time gate of the measurement.

Next, the operation of the image intensifier 20 will be described.

First, electromagnetic waves or radial rays that vary in energy and type enter on the object 27 that is to be imaged. For example, the X-rays E4 that vary in energy are emitted from the X-ray tube 28 to the object 27 that is to be imaged. The X-rays E4 passing through the object 27 enter on the incidence face 29 of the color scintillator 26 of the image intensifier 20.

The X-rays E4 entered on the incidence face 29 of the color scintillator 26 pass through the resin sheet 32 of, for example, white PET and enter the interior of the scintillator layer 31. The scintillator layer 31 reacts with the incident X-rays E4 and emits light beams. At this time, part of the X-rays E4 pass through the coating scintillator 51 and enter the acicular scintillator 50. Accordingly, both the coating scintillator 51 and the acicular scintillator 50 react with the X-rays E4 and emit light beams.

The fluorescent material used for the coating scintillator 51 and the fluorescent material used for the acicular scintillator 50 each react with the radial rays or electromagnetic waves of a corresponding type and energy, i.e., react with the high-energy X-rays E4 and the low-energy X-rays E4, respectively, and emit light beams.

For example, when fluorescent materials emitting light beams of different colors are used for the coating scintillator 51 and the acicular scintillator 50, the fluorescent materials react with the high-energy X-rays E4 and the low-energy X-rays E4, respectively, and emit light beams of the respective colors.

Also, when fluorescent materials having different emission lifetimes are used for the coating scintillator 51 and the acicular scintillator 50, the fluorescent materials react with the high-energy X-rays E4 and the low-energy X-rays E4, respectively, and emit light beams during the respective emission lifetimes.

In this manner, the X-rays E4 can be distinguished and converted into light beams in the coating scintillator 51 and the acicular scintillator 50 in terms of energy.

When the energy of the X-rays E4 incident on the scintillator layer 31 is high, the area of the coating scintillator 51 that reacts with the X-rays E4 is large. Accordingly, the rate of the X-rays E4 that pass through the interior of the coating scintillator 51 without losing energy and that reach the acicular scintillator 50 is increased.

The X-rays E4 with an energy reacting with the coating scintillator 51 to a small extent pass through the coating scintillator 51 and reach the acicular scintillator 50.

Since the interface between the coating scintillator 51 and the acicular scintillator 50 is uneven, the light beams emitted from the coating scintillator 51 efficiently enter the interior of the acicular scintillator 50. Furthermore, since the resin sheet 32 is composed of white PET, the light beams dispersed toward the resin sheet 32 are reflected by the white PET so as to enter the acicular scintillator 50.

The light beams entering the acicular scintillator 50 and the light beams emitted from the acicular scintillator 50 as a result of the reaction with the X-rays E4 travel toward the fiber-optic plate 30 and the photosensor 33 while being perfectly reflecting inside the columnar cells of the acicular scintillator 50. Thus, the dispersion of the light beams is suppressed inside the acicular scintillator 50.

That is to say, the acicular scintillator 50 formed of bundled optical fibers can suppress the dispersion of light beams traveling inside the optical fibers. As a result, the light beams inside the acicular scintillator 50 serving as image signals can be transmitted in a specific direction, i.e., to the fiber-optic plate 30 and the photosensor 33 without reducing the resolution.

The light beams passing through the acicular scintillator 50 travel inside the fiber-optic plate 30 formed of bundled optical fibers while being perfectly reflecting as in the acicular scintillator 50, and reach the photosensor 33.

At this time, the X-rays E4 having a high energy passing also through the acicular scintillator 50 are attenuated inside the fiber-optic plate 30. In other words, the X-rays E4 heading for the photosensor 33 are shielded by the fiber-optic plate 30.

Next, the light beams generated in the scintillator layer 31 are received by the light-receiving face of the photosensor 33 via the fiber-optic plate 30, and converted into the electrical signals E5 in the photoelectric face 35. At this time, the wavelengths of the light beams to be received are regulated by the filtering mechanism 52 of the photosensor 33, while the timing of receiving the light beams is adjusted by the timing adjustment mechanism 53. As a result, the light beams having different colors or emission lifetimes generated in the scintillator layer 31 are sorted by the filtering mechanism 52 and the timing adjustment mechanism 53 of the photosensor 33.

The electrical signals E5 converted in the photosensor 33 are leaded to the vacuum area 39 inside the image intensifier tube 25 closed with the color scintillator 26. That is to say, the image intensifier tube 25 functions as a discharge tube serving as the vacuum vessel 40 having the photoelectric face 35 of the photosensor 33 as a cathode, and electrons of the electrical signals E5 travel toward the anode 37.

At this time, an electric field is generated in the internal electrodes 36 inside the image intensifier tube 25 by the operation of voltages applied by the high-voltage power supply 24. Furthermore, an electron lens according to the curvature of the photoelectric face 35 of the photosensor 33 and the curvature of the output scintillator 38 is formed between the photoelectric face 35 of the photosensor 33 and the anode 37 inside the image intensifier tube 25.

As a result, the electrons leaded to the vacuum area 39 inside the image intensifier tube 25 are accelerated by the operation of the electric field so as to travel toward the anode 37, and enter on the output scintillator 38. At this time, the electrical signals E5 are amplified into an output image size of S4 by the operation of the electron lens.

Next, the electrical signals E5 are converted into light beams in the output scintillator 38, and the color images E6 are formed on the fluorescent output face 41. The color images E6 are then captured by the color camera 22. As a result, the X-rays E4 passing through the object 27 are visualized as the color images E6 formed by light beams having different colors or different emission lifetimes according to the energies of the X-rays E4 such that the state inside the object 27 can be checked by the X-rays E4 that vary in energy.

Light beams generated from fluorescent materials that have different emission lifetimes are converted into electrons that have strengths depending on the emission duration, and the electrons enter on the output scintillator 38. When the output scintillator 38 is a color scintillator capable of converting electrons into light beams of red, green, and blue having different luminescence ratios depending on the strengths of the electrons, the color images E6 having different colors according to the energies or the types of radial rays or electromagnetic waves are outputted from the fluorescent output face 41 of the output scintillator 38.

According to the color scintillator 26 of the image intensifier 20, the scintillator layer 31 includes an acicular or columnar scintillator, i.e., the acicular scintillator 50, and a particulate coating scintillator, i.e., the coating scintillator 51. Therefore, the traveling direction of light beams generated in the scintillator layer 31 is limited such that the loss is reduced, and areas where radial rays or electromagnetic waves react with the scintillator layer 31 are made uniform such that the sensitivity is improved without reducing the resolution.

Moreover, in the color scintillator 26, the scintillator layer 31 includes the acicular scintillator 50 and the coating scintillator 51 each having a fluorescent material emitting light beams with different colors or different emission lifetimes as a result of reaction with electromagnetic waves or radial rays that vary in energy or type. Thus, radial rays or electromagnetic waves that vary in energy or type can be distinguished and visualized at the same time.

Furthermore, when the color scintillator 26 includes fluorescent materials emitting light beams that have different colors and different emission lifetimes as a result of reaction with electromagnetic waves and radial rays that vary in energy or type, electromagnetic waves or radial rays that vary in energy or type can be visualized at the same time with higher sensitivity.

Moreover, according to the image intensifier 20, the scintillator layer 31, which is conventionally curved, is made flat. Accordingly, the resolution of the scintillator layer 31 in the outer portion is not reduced, and the sensitivity can also be improved by increasing the thickness of the scintillator layer 31. Furthermore, the difference in resolution between the central portion and the outer portion, which is an issue of the known image intensifier, is reduced; and the effective incident area S3 for radial rays or electromagnetic waves can also be large.

Similarly, according to the image intensifier 20, the face of the output scintillator 38 adjacent to the photosensor 33 is curved at a predetermined curvature so as to form an electron lens, whereas the fluorescent output face 41 adjacent to the color camera 22 is flat. Thus, images with little distortion can be obtained.

Moreover, in the image intensifier 20, when a flat CMOS sensor or a CCD sensor is used as the photosensor 33, the fiber-optic plate 30 can transmit light beams converted in the scintillator layer 31 to the photosensor 33 without using transmitting means such as a lens. Accordingly, clearer images can be obtained with the image intensifier 20.

In general, parts for the vacuum vessel 40 and parts for the photosensor 33, the internal electrodes 36, and the like arranged inside the vacuum vessel 40 are separately handled.

On the other hand, the image intensifier 20 includes the fiber-optic plate 30 serving as an optical substrate of the color scintillator 26 and the image intensifier tube 25 closed with the fiber-optic plate 30 such that the vacuum area 39 is formed. Accordingly, an opaque Al substrate, which is conventionally used for closing the image intensifier tube, is not required.

Therefore, according to the image intensifier 20, a white or transparent resin sheet 32 can be arranged on the color scintillator 26 as a protective film, and the sensitivity to low-energy radial rays or electromagnetic waves such as low-energy X-rays or ultraviolet rays, and light with short wavelengths can be improved. In particular, absorption of low-energy radial rays or electromagnetic waves by the Al substrate, which is a known problem, can be avoided such that the reduction in sensitivity is suppressed.

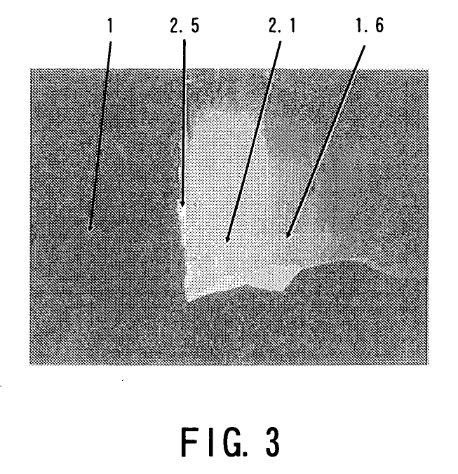

FIG. 3 is a diagram showing an example of image of an object obtained by using a plurality of scintillators having mutually difference structures.

With reference to FIG. 3, the portion indicated by an arrow 1 shows an image captured by a CCD camera where X-rays passing through an object were converted into light beams by only a red scintillator composed of Gd₂O₂S:Eu.

The portion indicated by an arrow 2.5 shows an image captured by the CCD camera where X-rays were converted into light beams by the color scintillator 26 including the fiber-optic plate 30, the acicular scintillator 50 composed of CsI:Tl arranged on the fiber-optic plate 30, the coating scintillator 51 composed of a red scintillator of Gd₂O₂S :Eu covering the acicular scintillator 50, and the protective resin sheet 32 composed of white PET.

The portion indicated by an arrow 2.1 shows an image captured by the CCD camera where X-rays were converted into light beams by the color scintillator 26 including the fiber-optic plate 30, the acicular scintillator 50 composed of CsI:Tl arranged on the fiber-optic plate 30, and the coating scintillator 51 composed of a red scintillator of Gd₂O₂S:Eu covering the acicular scintillator 50, i.e., without the protective resin sheet 32.

The portion indicated by an arrow 1.6 shows an image captured by the CCD camera where X-rays were converted into light beams by a known scintillator with high sensitivity including a fiber-optic plate and an acicular scintillator composed of CsI:Tl arranged on the fiber-optic plate.

The thickness of the red scintillator composed of Gd₂O₂S:Eu was approximately 70 μm, and the thickness of CsI:Tl was approximately 500 μm.

Moreover, the numerals of the arrows indicate relative amounts of the emission of the above-described color scintillators when the amount of the emission of the red scintillator is defined as unity. In other words, the amount of the emission of the color scintillator 26 including the fiber-optic plate 30, CsI:Tl, Gd₂O₂S:Eu, and white PET indicated by the arrow 2.5 is 2.5 times as large as that of the red scintillator.

Similarly, the amount of the emission of the color scintillator 26 including the fiber-optic plate 30, CsI:Tl, and Gd₂O₂S:Eu indicated by the arrow 2.1 is 2.1 times as large as that of the red scintillator; and the amount of the emission of the color scintillator including the fiber-optic plate and CsI:Tl indicated by the arrow 1.6 is 1.6 times as large as that of the red scintillator.

With reference to FIG. 3, the brightness of the known scintillator with high sensitivity including the fiber-optic plate and CsI:Tl was improved by adding Gd₂O₂S:Eu and white PET as components.

In particular, the brightness of the color scintillator 26 including the fiber-optic plate 30, CsI:Tl, Gd₂O₂S:Eu, and white PET was improved by 60% compared with the known scintillator with high sensitivity including the fiber-optic plate and CsI:Tl.

The thickness of the color scintillator 26 including the fiber-optic plate 30, CsI:Tl, Gd₂O₂S:Eu, and white PET was larger than that of the scintillator with high sensitivity including the fiber-optic plate and CsI:Tl approximately by 10%.

In order to enhance the brightness of the scintillator with high sensitivity including the fiber-optic plate and CsI:Tl up to that of the color scintillator 26 including the fiber-optic plate 30, CsI:Tl, Gd₂O₂S:Eu, and white PET, the thickness of the scintillator with high sensitivity including the fiber-optic plate and CsI:Tl must be numerically at least 500 to 800 μm.

It is known that the resolutions of the color scintillator 26 and the scintillator with high sensitivity are reduced by approximately 60% at the maximum geometrically in proportion to the thicknesses when X-rays enter in an oblique direction. Therefore, even if the thickness of the scintillator with high sensitivity including the fiber-optic plate and CsI:Tl is increased so as to obtain brightness equal to that of the color scintillator 26 including the fiber-optic plate 30, CsI:Tl, Gd₂O₂S:Eu, and white PET; the reduction in resolution of the x-rays entering in the oblique direction is unavoidable.

On the other hand, the color scintillator 26 including the fiber-optic plate 30, CsI:Tl, Gd₂O₂S:Eu, and white PET can improve the sensitivity while suppressing the reduction in resolution of the X-rays entering in the oblique direction without increasing the thickness to an extreme degree.

Instead of the fiber-optic plate 30, a glass component can be used as an optical substrate in the image intensifier 20. Moreover, instead of the color camera 22, visualizing means such as a color photosensor may be provided. Furthermore, the output scintillator 38 may not be a color scintillator but may be composed of a fluorescent material of a single color, and the monochromatic images may be captured by visualizing means such as a camera and the photosensor 33 instead of the color camera 22.

Moreover, the electrical-signal-amplify-means is not limited to the configuration that amplifies the electrical signals E5 with the electron lens, but may use other methods.

Moreover, the photosensor 33 may not include the timing adjustment mechanism 53 or the filtering mechanism 52. Furthermore, the color images E6 formed by the emission of the fluorescent materials having different emission lifetimes may be separated by adjusting the gating time of the color camera 22 without providing the timing adjustment mechanism 53 for the photosensor 33.

For example, when neutrons and X-rays or γ-rays enter on the color scintillator 26 so as to be visualized at the same time, the color scintillator 26 is formed of the coating scintillator 51 composed of terbium-activated gadolinium oxysulfide (Gd₂O₂S:Tb) serving as a green fluorescent material that reacts with thermal neutrons and of the acicular scintillator 50 composed of CsI:Na serving as a blue fluorescent material that reacts not with thermal electrons but with X-rays or y-rays, while the output scintillator 38 is formed of europium-activated yttrium oxysulfide (Y₂O₂S:Eu) emitting light beams of red, green, and blue having different luminescence ratios depending on the intensities of the electron rays toward the fluorescent output face 41 so as to form a color scintillator. With this configuration, the color images E6 generated by the individual radial rays can be captured in terms of color at the same time by adjusting the input gate of the color camera 22 such that the emission time is delayed.

As a result, even though radial rays or electromagnetic waves are converted into light beams in terms of color in the scintillator layer 31 as in the case where neutrons and X-rays or γ-rays enter on the color scintillator 26, a known problem that the type of radial rays cannot be discriminated from the amplified electrical signals E5 due to loss of color information during conversion of light beams into the electrical signals E5 and amplification of the electrical signals E5 can be solved.

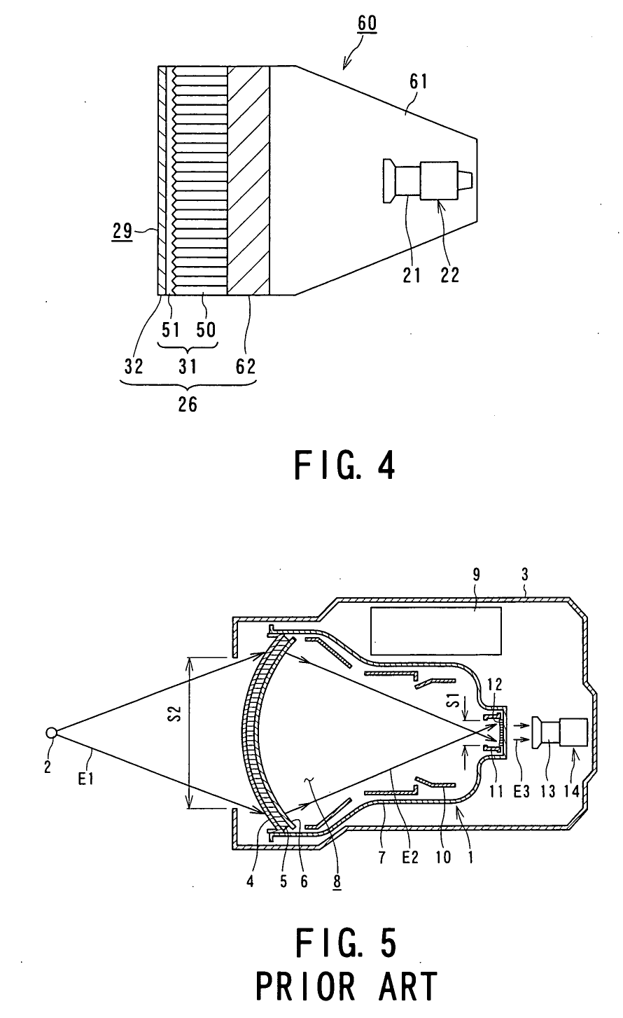

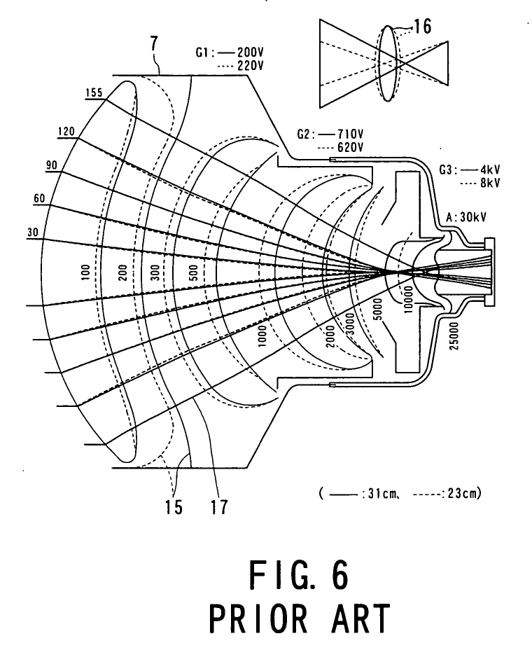

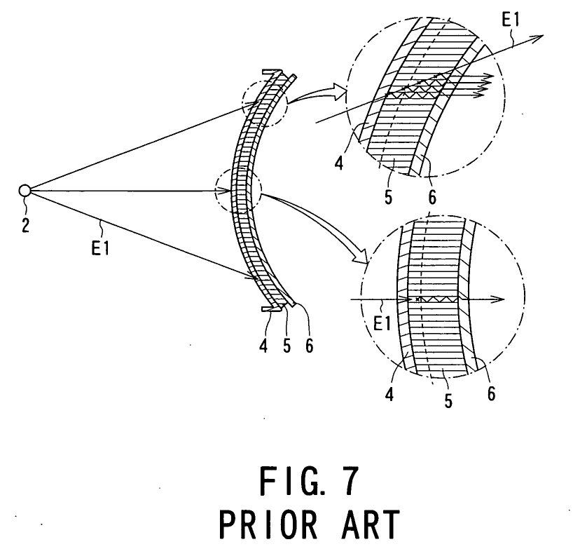

FIG. 4 is a structural drawing showing an image sensor according to a second embodiment of the present invention.

In an image sensor 60 shown in FIG. 4, the same numbers as those of the image intensifier 20 shown in FIG. 1 are added to elements equivalent to those of the image intensifier 20.

An image sensor 60 includes a color scintillator 26 and a color camera 22 arranged inside a camera obscura 61. The camera obscura 61 has an opening, and the color scintillator 26 is arranged at the opening such that an incidence face 29 of the color scintillator 26 faces the exterior of the camera obscura 61 so as to receive X-rays from the exterior of the camera obscura 61.

The color scintillator 26 includes a lead glass 62 serving as an optical substrate and a scintillator layer 31 arranged thereon. The boundary face between the lead glass 62 and the scintillator layer 31 is flat. Furthermore, the other face of the scintillator layer 31 remote from the lead glass 62 is flat, and is protected by a flat resin sheet 32.

The scintillator layer 31 of the color scintillator 26 includes an acicular scintillator 50 composed of a plurality of acicular or columnar cells and a coating scintillator 51 coating the acicular scintillator 50. The acicular scintillator 50 is arranged adjacent to the lead glass 62, and an area of the acicular scintillator 50 remote from the lead glass 62 is coated with the coating scintillator 51.

Moreover, the lead glass 62 of the color scintillator 26 adjacent to the interior of the camera obscura 61 is flat, and the color camera 22 faces the lead glass 62.

That is to say, the color scintillator 26 of the image sensor 60 includes the lead glass 62 instead of the fiber-optic plate 30 serving as an optical substrate of the color scintillator 26 shown in FIG. 2.

In general, the transmittance of the fiber-optic plate 30, which depends on wavelengths of electromagnetic waves or radial rays to be transmitted, is smaller than that of the lead glass 62 having the same thickness in terms of optical characteristics.

Therefore, when light beams emitted from the color scintillator 26 can be directly observed, the sensitivity can be improved by capturing light beams emitted from the color scintillator 26 that has the optical substrate of the lead glass 62 with the color camera 22.

Furthermore, when the lead glass 62 can be used as the optical substrate of the color scintillator 26, electromagnetic waves or radial rays entering the color scintillator 26 are shielded so as not to enter the color camera 22.

Accordingly, the sensitivity of the image sensor 60 can be improved while the reduction in resolution is suppressed as in the case of the image intensifier 20 shown in FIG. 1. Furthermore, the imaging system such as the color camera 22 can be protected against electromagnetic waves or radial rays.

In the image intensifier 20 and the image sensor 60, objects to be measured are not limited to X-rays but also electromagnetic waves such as light beams having short wavelengths and ultraviolet rays, or radial rays such as γ-rays and neutron rays.

The coating scintillator emits light beams having different emission lifetimes or colors from those of the acicular scintillator. However, emission conditions other than the emission lifetimes or colors may be different, and radial rays or electromagnetic waves that vary in energy or type may be discriminated on the basis of the emission conditions.

### INDUSTRIAL APPLICABILITY

With the color scintillator according to the present invention, it is possible to convert electromagnetic waves or radial rays which vary in type or energy to visible lights more simultaneously and effectively with less radiation dosage or less light intensity.

Furthermore, with the image sensor according to the present invention, it is possible to convert electromagnetic waves or radial rays which vary in type or energy to visible lights simultaneously with its color scintillator and amplify the converted visible lights effectively without reducing resolution so as to get differences in measured values due to differences in the types or energies of the electromagnetic waves and radial rays with higher sensitivity.

1. A color scintillator comprising: an optical substrate having bundled optical fibers; an acicular scintillator provided with the optical substrate, the acicular scintillator having either of an acicular crystal structure and a columnar crystal structure, the acicular scintillator reacting with at least one of an electromagnetic wave and a radial ray into light emitting; and a coating scintillator coating the acicular scintillator, the coating scintillator reacting with at least one of another electromagnetic wave and another radial ray which differ in either of an energy and a type from the electromagnetic wave and the radial ray reacting with the acicular scintillator into light emitting in a different color from an emitting color in the acicular scintillator.

2. A color scintillator comprising: an optical substrate having bundled optical fibers; an acicular scintillator provided with the optical substrate, the acicular scintillator having either of an acicular crystal structure and a columnar crystal structure, the acicular scintillator reacting with at least one of an electromagnetic wave and a radial ray into light emitting; and a coating scintillator coating the acicular scintillator, the coating scintillator reacting with at least one of another electromagnetic wave and another radial ray which differ in either of an energy and a type from the electromagnetic wave and the radial ray reacting with the acicular scintillator into light emitting in a different emission lifetime from that in the acicular scintillator.

3. A color scintillator comprising: an optical substrate having bundled optical fibers; an acicular scintillator provided with the optical substrate, the acicular scintillator having either of an acicular crystal structure and a columnar crystal structure, the acicular scintillator reacting with at least one of an electromagnetic wave and a radial ray into light emitting; and a coating scintillator coating the acicular scintillator, the coating scintillator reacting with at least one of another electromagnetic wave and another radial ray which differ in either of an energy and a type from the electromagnetic wave and the radial ray reacting with the acicular scintillator into light emitting in a different color and a different emission lifetime from those in the acicular scintillator.

4. A color scintillator comprising: an optical substrate having bundled optical fibers; an acicular scintillator provided with the optical substrate, the acicular scintillator having either of an acicular crystal structure and a columnar crystal structure, the acicular scintillator reacting with at least one of an electromagnetic wave and a radial ray into light emitting; and a coating scintillator coating the acicular scintillator, the coating scintillator reacting with at least one of another electromagnetic wave and another radial ray which differ in either of an energy and a type from the electromagnetic wave and the radial ray reacting with the acicular scintillator into light emitting in a different emitting condition from that in the acicular scintillator.

5. An image sensor comprising: a color scintillator according to one of claim 1, 2 and 3; and a photosensor receiving light generated by the color scintillator to convert the light into an electrical signal, the photosensor having a timing adjustment mechanism which adjusts a timing to receive the light and a filtering mechanism sorting the light by wavelength.

6. An image sensor comprising: a color scintillator according to one of claim 1, 2 and 3; a photosensor receiving light generated by the color scintillator to convert the light into an electrical signal; an electrical-signal-amplify-means for amplifying the electrical signal by accelerating electrons with an operation of an electric field; and an output scintillator converting the electrical signal amplified by the electrical-signal-amplify-means into an image.

7. An image sensor comprising: a color scintillator according to one of claim 1, 2 and 3; a photosensor receiving light generated by the color scintillator to convert the light into an electrical signal, the photosensor having a photoelectric face of which a curvature forms an electron lens; an electrical-signal-amplify-means for amplifying the electrical signal by accelerating electrons with an operation of an electric field; and an output scintillator converting the electrical signal amplified by the electrical-signal-amplify-means into an image, the output scintillator having a curvature forming another electron lens in a side of the photoelectric face.

8. An image sensor comprising: a color scintillator according to one of claim 1, 2 and 3, the color scintillator including an optical substrate of which an incident side surface of the electromagnetic wave and the radial ray is flat and a light output side surface is curved; a photosensor receiving light generated by the color scintillator to convert the light into an electrical signal, the photosensor having a photoelectric face of which a curvature forms an electron lens; an electrical-signal-amplify-means for amplifying the electrical signal by accelerating electrons with an operation of an electric field; and an output scintillator converting the electrical signal amplified by the electrical-signal-amplify-means into an image, the output scintillator having a curvature forming another electron lens in a side of the photoelectric face.

9. An image sensor comprising: a color scintillator according to one of claim 1, 2 and 3; a photosensor receiving light generated by the color scintillator to convert the light into an electrical signal, the photosensor having a photoelectric face of which a curvature forms an electron lens; an electrical-signal-amplify-means for amplifying the electrical signal by accelerating electrons with an operation of an electric field; and an output scintillator converting the electrical signal amplified by the electrical-signal-amplify-means into an image, the output scintillator having a curved surface of which a curvature forms another electron lens in a side of the photoelectric face and a flat fluorescent output surface.

10. An image sensor comprising: a color scintillator according to one of claim 1, 2 and 3, the optical substrate partially constituting a vacuum vessel; a photosensor receiving light generated by the color scintillator to convert the light into an electrical signal, the photosensor having a photoelectric face of which a curvature forms an electron lens; an electrical-signal-amplify-means for amplifying the electrical signal by accelerating electrons with an operation of an electric field; and an output scintillator converting the electrical signal amplified by the electrical-signal-amplify-means into an image, the output scintillator having a curvature forming another electron lens in a side of the photoelectric face.

11. An image sensor comprising: a color scintillator according to one of claim 1, 2 and 3; a photosensor receiving light generated by the color scintillator to convert the light into an electrical signal, the photosensor having a photoelectric face of which a curvature forms an electron lens; an electrical-signal-amplify-means for amplifying the electrical signal by accelerating electrons with an operation of an electric field; and an output scintillator converting the electrical signal amplified by the electrical-signal-amplify-means into an image constituted with a light of which a luminescence ratio of red, green and blue varies according to intensities of the electrons, the output scintillator having a curved surface of which a curvature forms another electron lens in a side of the photoelectric face and a flat fluorescent output surface.
